(19) United States
(12) Patent Application Publication
(10) Pub. No.: US 2026/0155564 A1
(43) Pub. Date: Jun. 4, 2026

(54) COST-EFFECTIVE RECEIVER ANTENNA DESIGN FOR HIGH-PRECISION GLOBAL NAVIGATION SATELLITE SYSTEMS

(71) Applicant: Jason Sean O'Flanagan, Austin, TX (US)

(72) Inventor: Jason Sean O'Flanagan, Austin, TX (US)

(21) Appl. No.: 18/823,244

(22) Filed: Sep. 3, 2024

(51) Int. Cl. H01Q 1/52; H01Q 9/04

(52) U.S. Cl. CPC H01Q 1/526; H01Q 9/0407

(57) ABSTRACT

A cost-effective approach is presented to mitigate non-symmetry in antenna patterns of GNSS receivers that employ patch antennas. The approach uses a combination of a ground plane and a 3D printed choke ring. The choke ring, which can be made of either ferrous or graphene based PLA, significantly reduces the size of the ground plane required to ensure reliable reception from satellites in the low horizon. Moreover, this method works also for square patch antennas, which are inexpensive to fabricate, compared to all other antenna options. The use of 3D printing using PLA allows the cost-effective fabrication of choke rings with precise parameter profiles. The proposed approach is cost-effective, as it does not require the use of expensive components. It is also versatile, as it can be used with a variety of patch antennas, including the inexpensive square patch antenna. The proposed approach is therefore a promising new method for improving the performance of GNSS receivers in challenging environments. The methods disclosed can also be used for other applications such as vehicle-to-vehicle communications where non-symmetric antenna patterns can cause system performance to be degraded.

### PRIORITY CLAIM

This application claims priority to U.S. Provisional Ser. No. 63/581,515 entitled COST-EFFECTIVE RECEIVER ANTENNA DESIGN FOR HIGH-PRECISION GLOBAL NAVIGATION SATELLITE SYSTEMS” by Jason O'Flanagan and filed on Sep. 8, 2023.

### TECHNICAL FIELD

Global Navigation Satellite Systems (GNSS) are used to determine the position, velocity, and time of a receiver on the Earth. GNSS antennas are used to receive the signals from GNSS satellites. There are many different types of GNSS antennas available, each with its own advantages and disadvantages.

The Wide Area Augmentation System (WAAS) is a satellite-based augmentation system (SBAS) that provides improved accuracy, integrity, and availability to GNSS users in North America. WAAS uses a network of ground stations to monitor the GPS signal and transmit corrections to GPS receivers. These corrections can be used to improve the accuracy of GPS position estimates by up to a factor of 10. WAAS also provides integrity information to GPS receivers, which helps to ensure that the GPS signal is reliable and can be trusted for safety-critical applications. There are other SBAS systems in operation around the world, including EGNOS, MSAS, and QZSS.

### BACKGROUND

A GNSS receiver employs an antenna to receive the signal from the satellite. Some of the most common types of GNSS antennas include:

Patch antennas are a versatile and effective choice for GNSS use. They offer a number of advantages over other types of antennas, including their lightweight, compact size, and wideband performance. They are relatively inexpensive and easy to manufacture, and they have a wide bandwidth. Especially the square patch antenna is cost-effective to fabricate. However, patch antennas can be susceptible to multipath errors.

Yagi-Uda antennas are a type of directional antenna that is commonly used in GNSS receivers. They have a narrow beamwidth, which makes them well-suited for applications where it is important to receive signals from specific satellites. However, Yagi-Uda antennas can be more expensive than patch antennas, and they require more complex tuning.

Horn antennas are a type of high-gain antenna that is commonly used in GNSS receivers. They have a very narrow beamwidth, which makes them well-suited for applications where it is important to receive signals from specific satellites with high accuracy. However, horn antennas can be very expensive, and they require more complex tuning than patch antennas or Yagi-Uda antennas.

Helical antennas have a directional radiation pattern, meaning they are more effective at receiving signals from certain directions than others. Helical antennas are more susceptible to wind and rain than other types of GNSS antennas. They are more complex to design and manufacture than other types of GNSS antennas.

Pinwheel antennas have lower gain than other types of GNSS antennas, making them less sensitive to weak signals. They are more susceptible to wind and rain than other types of GNSS antennas. They are more complex to design and manufacture than other types of GNSS antennas. They can be difficult to align properly and can be more susceptible to interference from other radio signals.

The receiving pattern of the antenna in the direction of the satellite must be strong enough to produce a signal to noise ratio (SNR) that allows the receiver to decode the information from the satellite. This must also be true when radio signals from a satellite are reflected off of objects in the environment and reach the receiver antenna via multiple paths (multipath phenomena).

Multipath phenomena can lead to inaccurate positioning as a result of both incorrect phase information and of extremely low amplitudes of the received signal from certain satellite directions, where the reflected signal is out of phase with the direct signal from the satellite or when the receiving pattern is simply too low in the direction of the satellite.

A ground plane can help mitigate both non-symmetry in the receiving pattern and multipath effects, with a larger ground plane being more effective. The non-symmetry in the receiving pattern can cause satellites, especially in the low horizon, to be added and dropped as the GNSS antenna turns.

Ground planes are typically made of metal, such as copper or aluminum. They can be any shape, but they are often square or circular. The size of the ground plane depends on the frequency of the GNSS signals that the antenna is designed to receive. The following commercially available systems, which can be purchased from www.canalgeomatics.com, employ antennas mounted on ground planes: (i) PCTEL 3961D Low Noise Embedded GPS Antenna, (ii) Tallysman TW1010 Embedded Single-Band GNSS Antenna, (iii) Tallysman TW2605 Embedded Iridium Antenna, and (iv) Tallysman TW3872 Dual-Band GNSS Antenna (Pre-Filtered).

A choke-ring ground plane is a type of ground plane that is used in GNSS receivers to mitigate multipath effects. It consists of a metal ring that surrounds the antenna element and helps to block reflected signals from reaching the antenna.

The choke-ring ground plane works by creating a “shadow zone” around the antenna where reflected signals cannot reach. This helps to reduce the overall level of reflected signals that reach the antenna, which can improve the accuracy of positioning results; see Maqsood et al, “Effects of Ground Plane on the Performance of Multipath Mitigating Antennas for GNSS,” 2010 Loughborough Antennas & Propagation Conference, 8-9 Nov. 2010, Loughborough, UK.

RF absorbers can be used to reduce multipath effects in GNSS receivers by absorbing the energy of reflected signals. A 3D printed radio frequency absorber is a device that is used to absorb radio frequency (RF) energy. It is typically made of a material that has a high dielectric constant and a high loss tangent. These properties allow the material to absorb RF energy, preventing it from reflecting or transmitting.

Acrylonitrile butadiene styrene (ABS) and polylactic acid (PLA) are two of the most popular materials for 3D printing. They are both thermoplastics, which means that they can be melted and solidified repeatedly. This makes them ideal for 3D printing, as it allows for the creation of complex objects with intricate details; see U.S. Patent Application, US2016/0263823 A1.

ABS is a more rigid and durable material than PLA. It is also more heat-resistant, making it suitable for use in applications where the printed object will be exposed to high temperatures. However, ABS is also more difficult to print than PLA, and it can emit fumes that are harmful to breathe in.

### BRIEF SUMMARY

A cost-effective approach is proposed to mitigate non-symmetry of antenna patterns in GNSS receivers that employ patch antennas. The approach uses a combination of a ground plane and a 3D printed choke ring. The choke ring, which can be made of either ferrous or graphene-based PLA, significantly reduces the size of the ground plane required to ensure reliable reception from satellites in the low horizon. Moreover, this method works for square patch antennas, which are inexpensive to fabricate compared to all other antenna options. The use of 3D printing using PLA allows for the cost-effective fabrication of choke rings with precise parameter profiles.

### BRIEF DESCRIPTION OF THE DRAWINGS

For a more complete understanding of the present disclosure, reference is now made to the following descriptions taken in conjunction with the accompanying drawings.

FIG. 1 is a schematic illustrating a patch antenna mounted on a ground plane. The solid arrow points towards the single satellite used for performance evaluation. The angle between the surface of the patch antenna and the direction to said satellite is given by the elevation angle Θ, so that Θ=90 degrees corresponds to the situation where the dashed arrow, which is normal to the surface of the patch antenna, is parallel to the solid arrow. The angle φ denotes the azimuthal orientation of the patch antenna with respect to the dashed arrow.

FIG. 2 is a plot of the SNR as a function of Θ achieved with a ADFGP.50A Taoglas square patch antenna (www.taoglas.com) mounted on a ground plane of 85 millimeter diameter made from F4R PCB material, a combination of fiberglass and copper. The corresponding schematic is shown in FIG. 1. Each thin solid line corresponds to a particular value of the azimuthal angle φ. The upper and lower envelopes (with respect to the azimuthal angle φ) are shown as fat solid lines.

FIG. 3 is a schematic illustrating a patch antenna mounted on a ground plane with a surrounding choke ring. The solid arrow points towards the single satellite used for performance evaluation. The angle between the surface of the patch antenna and the direction to said satellite is given by the elevation angle Θ, so that Θ=90 degrees corresponds to the situation where the dashed arrow, which is normal to the surface of the patch antenna, is parallel to the solid arrow. The angle φ denotes the azimuthal orientation of the patch antenna with respect to the dashed arrow.

FIG. 4 is a plot of the SNR as a function of Θ achieved with a ADFGP.50A Taoglas square patch antenna (www.taoglas.com) mounted on a ground plane of 85 millimeter diameter made from F4R PCB material with a surrounding ferrous choke ring. The ferrous choke ring is made using a conductive PLA on a standard 0.4 millimeter 3D printer. The dimensions of the choke ring are: 85 millimeter in diameter, 5 millimeters tall with a 45 degree champer on the outside. The corresponding schematic is shown in FIG. 3. Each thin solid line corresponds to a particular value of the azimuthal angle φ. The upper and lower envelopes (with respect to the azimuthal angle φ) are shown as fat solid lines.

### DETAILED DESCRIPTION

The detailed description will be given by using specific configurations of GNSS receivers, patch antennas, ground planes, and choke rings that were constructed and tested in a laboratory.

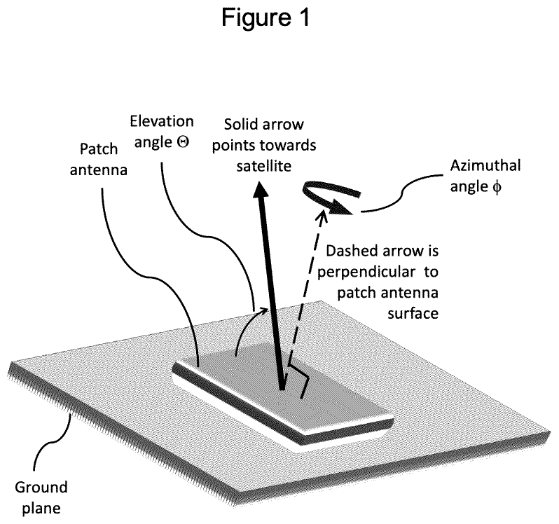

FIG. 1 is a schematic illustrating a patch antenna mounted on a ground plane. The solid arrow points towards the single satellite used for performance evaluation. The angle between the surface of the patch antenna and the direction to said satellite is given by the elevation angle Θ, so that Θ=90 degrees corresponds to the situation where the dashed arrow, which is normal to the surface of the patch antenna, is parallel to the solid arrow. The angle φ denotes the azimuthal orientation of the patch antenna with respect to the dashed arrow.

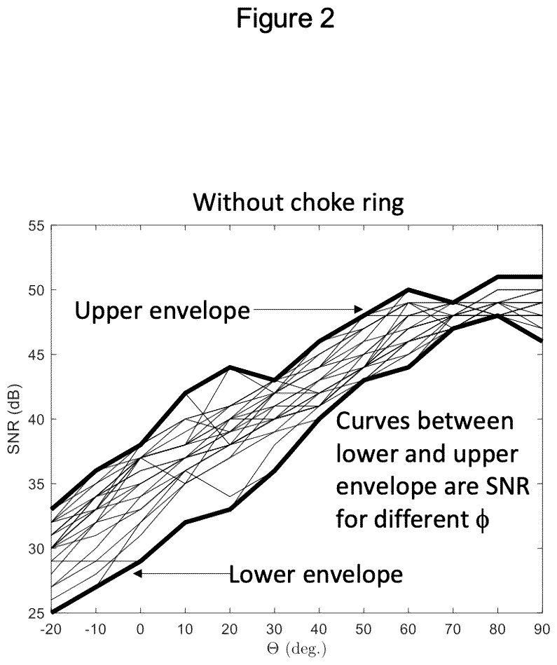

FIG. 2 is a plot of the SNR as a function of Θ achieved with a ADFGP.50A Taoglas square patch antenna (www.taoglas.com) mounted on a ground plane of 85 millimeter diameter made from F4R PCB material, a combination of fiberglass and copper. The corresponding schematic is shown in FIG. 1. Each thin solid line corresponds to a particular value of the azimuthal angle φ. The upper and lower envelopes (with respect to the azimuthal angle φ) are shown as fat solid lines.

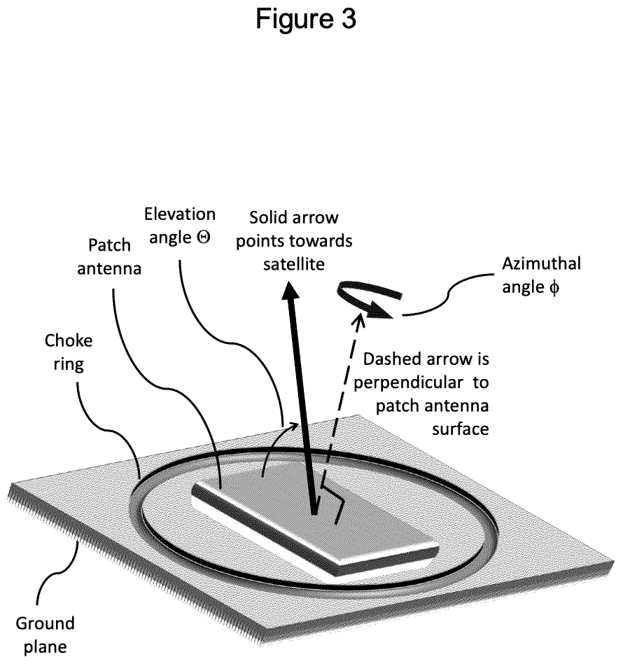

FIG. 2 illustrates the problem with the conventional square patch antenna mounted on a small ground plane when the satellite is in the low horizon. Indeed, for a fixed Θ in the low horizon, 10 deg<Θ<30 deg, the SNR varies strongly with the azimuthal orientation of the antenna, thus creating a large spread between the upper and lower envelopes. This non-symmetry of the antenna pattern of the GNSS receiver can cause low-horizon satellites to be added and dropped as the antenna turns. While retaining the small ground plane and the square patch antenna, this non-symmetry can be mitigated with the configuration illustrated in FIG. 3.

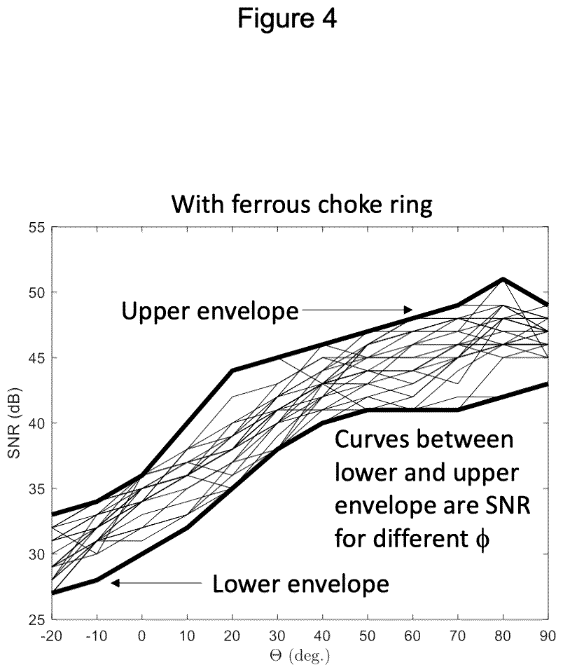

FIG. 3 is a schematic illustrating a patch antenna mounted on a ground plane with a surrounding choke ring. FIG. 4 is a plot of the SNR as a function of Θ achieved with a ADFGP.50A Taoglas square patch antenna (www.taoglas.com) mounted on a ground plane of 85 millimeter diameter made from F4R PCB material with a surrounding ferrous choke ring.

The ferrous choke ring is made from a conductive PLA on a standard 0.4 millimeter 3D printer. The dimensions of the choke ring are: 85 millimeter in diameter, 5 millimeters tall with a 45 degree champer on the outside. It is mounted with screws that help connect the ground plane conductively to the ring. The same benefits can be obtained with the more expensive graphene PLA based choke ring with the same dimensions.

For low-horizon satellites, the performance depicted in FIG. 4 is much better than the performance depicted in FIG. 2. Indeed, the spread among the SNR curves in the range 10 deg<Θ<30 deg is significantly smaller in FIG. 4, thus making it less likely that low-horizon satellites are added and dropped as the receiver turns.

We can quantify the improvement achieved in FIG. 4 over FIG. 2 using the area between the upper and lower envelopes. For low-horizon satellites, the area between the upper and lower envelopes in FIG. 4 is 16% lower than the same area in FIG. 2. Hence, the choke ring makes the antenna pattern significantly more symmetrical in the important range 10 deg<Θ<30 deg.

The designs described here are obtained by first creating a large number of choke rings in the laboratory with different physical parameters through 3D printing. Each design is then evaluated by use of an actual GNSS receiver that receives the signals from an actual satellite.

While the choke rings considered here have uniform cross sections, it is entirely possible with current 3D printing technology to design choke rings with non-uniform cross sections.

What is claimed is:

1. A method for mitigating non-symmetry in antenna patterns in GNSS receivers that employ patch antennas, the method comprising:
providing a ground plane;
providing a 3D printed choke ring;
positioning the choke ring on the ground plane; and
operating the GNSS receiver.

2. The method of claim 1, wherein the choke ring is made of either ferrous or graphene based PLA.

3. The method of claim 1, wherein the choke ring significantly reduces the size of the ground plane required to ensure reliable reception from satellites in the low horizon.

4. The method of claim 1, wherein the choke ring works also for square patch antennas.

5. The method of claim 1, wherein the use of 3D printing using PLA allows the cost-effective fabrication of choke rings with precise parameter profiles.

6. An apparatus for mitigating non-symmetry in antenna patterns in GNSS receivers that employ patch antennas, comprising:
a ground plane;
a 3D printed choke ring;
a patch antenna; and
a receiver circuit for receiving GNSS signals from satellites wherein the choke ring is configured to:
reduce the size of the ground plane required to ensure reliable reception from satellites in the low horizon; and
mitigate multipath effects.

7. The apparatus of claim 6, wherein the choke ring is made of ferrous or graphene-based PLA.

8. The apparatus of claim 6, wherein the ground plane is smaller than the ground plane required in the absence of the choke ring.

9. The apparatus of claim 6, wherein the patch antenna is less expensive to fabricate than all other antenna options.

10. The apparatus of claim 6, wherein the choke ring is fabricated using 3D printing.

11. The apparatus of claim 6, wherein the choke ring has a non-uniform cross section.
